(19) United States
(12) Patent Application Publication
(10) Pub. No.: US 2010/0239439 A1
(43) Pub. Date: Sep. 23, 2010

(54) ENGINE DRIVEN PUMP DISCONNECT MECHANISM

(76) Inventors: Thomas M. Zwiep, Galesburg, MI (US); Dean R. Pollee, Mattawan, MI (US); Donald S. Bolton, Lawton, MI (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/405,838

(22) Filed: Mar. 17, 2009

(51) Int. Cl. F16D 11/14; F16H 1/06; F16D 25/06; F04B 17/00

(52) U.S. Cl. 417/321; 192/69.8

(57) ABSTRACT

An engine driven pump includes a drive apparatus that is assisted into the disengaged condition prior to disconnect by the ported pressure in the pump. A spring-biased actuator assembly is fluidly connected to a depressure valve of the pump, and along with its spring bias, urges a yoke into a disengaged position to disengage the gear faces of the mechanism. A trigger link held by a solenoid plunger normally retains the yoke in an engaged position. A drive socket can be accessed to return the yoke, and hence the gear faces, into the engaged position. The pump can be disengaged under command during flight or when the aircraft is on the ground, and can only be re-engaged when the aircraft is on the ground. The drive apparatus has few rotating components to reduce rotational inertia; and is enclosed within a housing with no exposed components with all parts continually lubricated.

### FIELD OF THE INVENTION

The present invention relates generally to a drive apparatus which transmits force from a source of power to a driven assembly; and more specifically to a disconnect mechanism for an engine driven pump (EDP) used on an aircraft.

### BACKGROUND OF THE INVENTION

In aircraft applications, EDP's are typically installed directly to an engine gearbox, resulting in power being transmitted to the pump via rotation whenever the aircraft engines are operable. The pump provides hydraulic fluid or other fluid at pressure to systems or components in the aircraft. Typically the EDP is used to provide hydraulic fluid to the primary hydraulic system in the aircraft for extension/retraction of landing gear and movement of flight controls (flaps, ailerons, rudders, spoilers, and the like).

One type of pump used for such applications is a variable displacement axial piston pump, wherein a cylinder barrel containing multiple pistons is driven by the engine through a drive shaft. As the barrel rotates, the pistons reciprocate within their bores, intaking and discharging fluid through a stationary valving surface. The cylinder barrel is supported by a bearing that allows for freedom of alignment and is optimally positioned to react to loads produced by the pumping forces. The axial pumping force imparted to the pistons is reacted at the piston shoe to the hanger (cam) interface. The hanger is supported by bearings, providing rotational capability about an axis perpendicular to the cylinder barrel. Rotation of the hanger changes the angle of the surface upon which the piston shoes run, in turn varying the piston stroke, which yields a displacement change. Rate and stroking pistons are located on opposite sides of the hanger rotation axis to provide a biasing load, and stroke/destroke control of the hanger. Pump outlet pressure is controlled by the positioning of a three way compensator valve. The valve position is dictated by the force of the discharge pressure on the valve spool area versus a preset valve spring force. The compensator valve meters a volume of fluid to the stroking piston proportional to the outlet pressure. Changes in outlet pressure result in valve spool movement and subsequent hanger angle changes via the movement of a stroking piston which is balanced by a rate spring. Certain EDP's are characterized as having three distinct modes of operation: i) a normal mode; ii) a depressurized mode; and iii) a disengaged mode. The EDP includes a depressurization solenoid valve which is normally de-energized when the EDP is in the normal mode, and the EDP functions as above with standard hanger control. In certain situations, such as engine relight, system overheating, or system leakage, the depressurization solenoid is energized and the pump outlet pressure is applied directly against the stroking piston, which destrokes the pump (reduces the hanger angle) and minimizes the outlet pressure of the pump. Additionally, when the depressurization solenoid valve is energized, outlet pressure is directed to a valve which activates and blocks the discharge port, preventing discharge flow from the pump to the system. In the third, disengaged mode, the pump is disconnected from the input drive.

Regarding pump disconnect, certain EDP's include a disconnect mechanism located within the input power path which transmits force from the engine to the pump. The disconnect mechanism includes a pair of oppositely-facing gear faces with radial teeth, which when in engaged relation, complete the power path to the pump; and when in axially-spaced relation, disconnect or disengage the pump from the engine. The gear faces are normally spring-biased against each other into the engaged or operational position. In one known technique, a clutch disengagement piston is operable against a shoulder on the drive shaft to overcome the spring bias and move the drive shaft, and hence drive shaft gear face, away from the gear face on the driven shaft. The piston receives outlet port pressure from the pump which is controlled by a solenoid, and includes a strong spring set to overcome the disengagement forces when there is high operating torque on the pump. The clutch disengagement piston can be energized by a dedicated command during flight, or manually operated via a hex head cam shaft when the aircraft is on the ground. When the piston has transversed a set distance, a spring-loaded lockout pin drops in behind the piston to lock the assembly in the disengaged position.

Provision is made for manually re-engaging the clutch on the ground when the engine is shut down. A technician manually pulls a ring located on the lockout pin which releases the clutch disengagement piston to allow the gear faces to move toward each other and re-engage.

A later technique is shown in U.S. Pat. No. 6,935,479, which uses an actuator arm connected to a yoke to force an annular contact plate forwardly against a retaining ring. The retaining ring in turn causes disengagement levers to pivot against an output member, connected to one gear face, and move the output member backwardly away from an input member, connected to the other gear face, to disengage the gear teeth. Multiple spring sets are used to urge the contact plate against the retaining ring to facilitate disengagement when there is high operating torque on the pump. A latch assembly including an armature (plunger) engages a linkage assembly which in turn contacts the actuator arm to prevent movement of the arm and disengagement of the clutch. When a motor is energized to retract the armature, the linkage assembly releases the actuator arm to allow the arm to move in the above-described manner to disengage the clutch. The linkage assembly can be manually manipulated while the aircraft is on the ground and the engine is shut down via a drive member connected to the linkage assembly to move the actuator arm and yoke back to its initial position and thereby re-engage the teeth on the gear faces.

While the known techniques provide certain advantages for a clutch that disconnects a source of power from a driven assembly, it is believed that there is a demand in the industry for an improved disconnect mechanism, and in particular for an improved disconnect mechanism for an EDP which is simple in operation, has fewer and lighter spring sets, and is disengaged when there is lower operating torque on the pump. Moreover, it is believed there is a continuing demand for a mechanism that i) has few rotating components such that the rotational inertia is minimized; and ii) is enclosed within a housing such that the components are continually lubricated and the risk of contaminants entering the assembly is minimized.

### SUMMARY OF THE INVENTION

The present invention provides a drive apparatus for coupling a source of power to a driven assembly, and more particularly to a disconnect mechanism for an engine driven pump for aircraft applications. The mechanism is simple in operation, has fewer and lighter spring sets than previous known techniques, and disconnects the source of power from the driven assembly when the pump has low operating torque.

According to the invention, the mechanism is assisted into the disengaged condition by the ported pressure in the pump when the pump is in the depressurized mode and has low operating torque. The porting of the pressure, and the lower torque allows the number of spring sets to be reduced, and the disconnect mechanism is simplified. The mechanism also has i) few rotating components such that its rotational inertia is reduced; and ii) is enclosed within the pump housing such that the components are not exposed, the components are continually lubricated and the risk of contaminants entering the assembly is minimized.

The disconnect mechanism includes a pair of oppositely-facing gear faces with radial teeth, one of which is on a sliding interface shaft connected to an input shaft, and the other of which is on a driven shaft. The gear faces are normally spring-biased against each other into the engaged condition. An annular block member is rotationally fixed and provides axial support to the rotatable sliding interface shaft. Drive pins on the block are engaged with a yoke, pivotally mounted to the pump housing. The arms on the other end of the yoke are connected to a spring-biased actuator assembly, and guided by a linkage assembly. The linkage assembly includes a trigger link pivotally supported on the housing, and having an arcuate groove which receives a link pin connected to the ends of the lever arms.

The actuator is fluidly connected to the depressure valve of the pump, and has a piston which is urged outwardly by the pressure of the fluid during depressurization of the pump prior to disconnect. Along with the spring bias, the piston urges the yoke into the disengaged position. When the yoke is moved into the disengaged position, the annular block is forced against the sliding interface shaft and the gear faces are separated from each other. A single spring on the actuator is sufficient by itself to move the yoke when the pump is not operational; and otherwise the fluid pressure applied against the actuator piston during depressurization assists in moving the yoke to separate the gear faces.

The trigger link is retained in a fixed position by a solenoid plunger, which engages a shoulder on the link, and which thereby retains the yoke. When in the engaged position, a spring acts to keep the gear faces in the engaged condition. With the exception of the alignment support provided by the annular block member to the sliding interface shaft, the trigger and yoke mechanism are isolated from the rotating members when the pump is operating in the engaged position. The solenoid plunger can be energized and retracted by a dedicated command when power is available during flight or on the ground. The solenoid plunger can also be manually retracted when the aircraft is on the ground. When the plunger retracts, the trigger link pivots as the actuator piston extends. The yoke pivots and causes the block member to move axially against the sliding interface shaft, and hence cause the block to axially move and force the sliding interface shaft away from the driven shaft - separating the gear teeth and disengaging the mechanism.

When it is desired to re-engage the mechanism when the aircraft is on the ground and the engine is shut down, a technician can access a reset socket connected to the yoke to manually force the yoke, and accordingly the trigger link and actuator piston, back into the engaged position, where the solenoid plunger then locks against the trigger link.

The yoke, trigger link and actuator of the disconnect mechanism are enclosed within the pump housing and along with the gear faces, are continuously lubricated by the pump case pressure and protected from external contaminants.

Further features of the present invention will become apparent to those skilled in the art upon reviewing the following specifications and attached drawings.

### BRIEF DESCRIPTION OF THE DRAWINGS

FIG. 1 is a cross-sectional side view of an engine driven pump constructed according to the present invention;

FIG. 2 is a schematic representation of a fluid circuit for the pump of FIG. 1;

FIG. 3 is an end view of the drive apparatus for the pump of FIG. 1;

FIG. 4 is a cross-sectional side view of the drive apparatus, taken substantially along the plane described by the lines 4-4 in FIG. 3;

FIG. 5 is a cross-sectional side view of the drive apparatus, taken substantially along the plane described by the lines 5-5 in FIG. 3;

FIG. 6 is an elevated perspective view of the drive apparatus for the pump of FIG. 1, with the housing removed for clarity;

FIG. 7 is an enlarged view of a portion of the disconnect mechanism for the drive apparatus of FIG. 6;

FIG. 8 is a partial cross-sectional side view of the drive apparatus of FIG. 3;

FIG. 9 is a partial cross-sectional side view similar to FIG. 8, but showing the disconnect mechanism in a disengaged mode;

FIG. 10 is a schematic representation of the fluid circuit, illustrating the fluid circuit in a disengaged mode;

FIG. 11 is a side view of the drive mechanism of FIG. 3; and

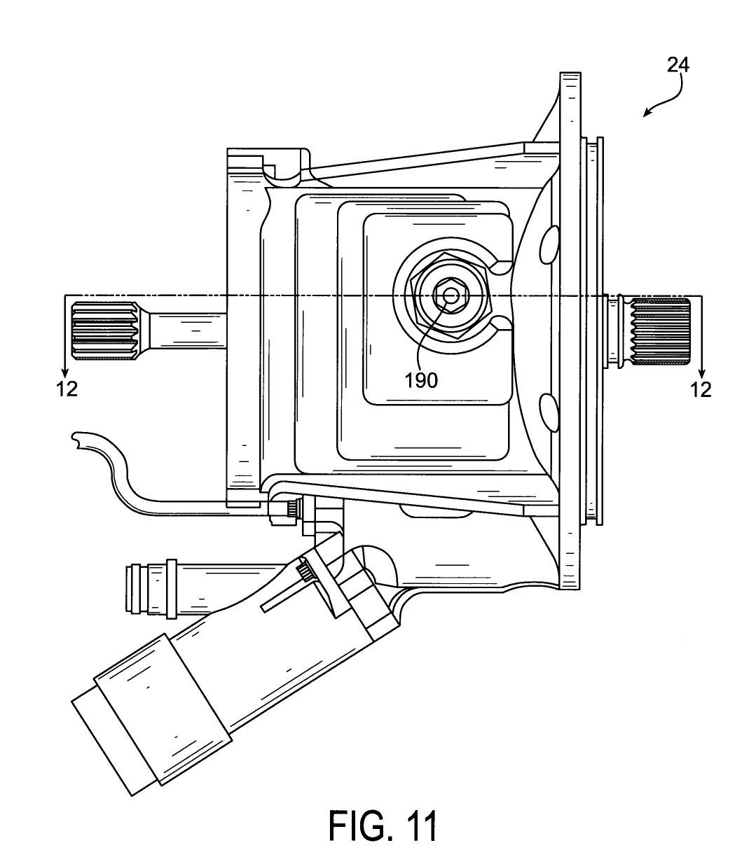

FIG. 12 is a cross-sectional side view of the drive mechanism, taken substantially along the plane described by the lines 12-12 of FIG. 11.

### DETAILED DESCRIPTION OF THE PREFERRED EMBODIMENTS

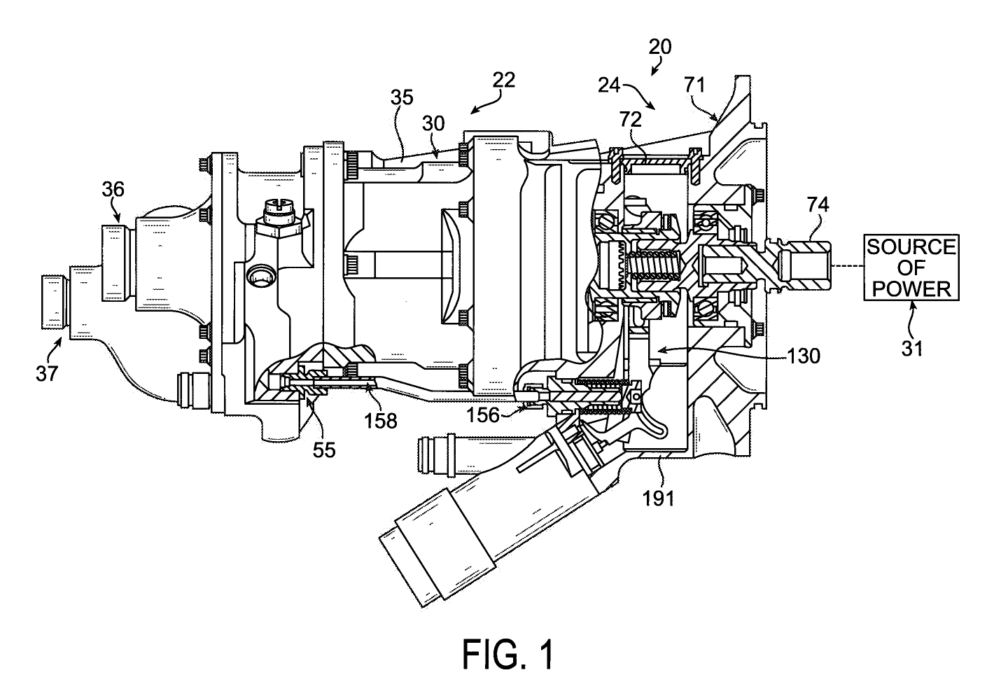

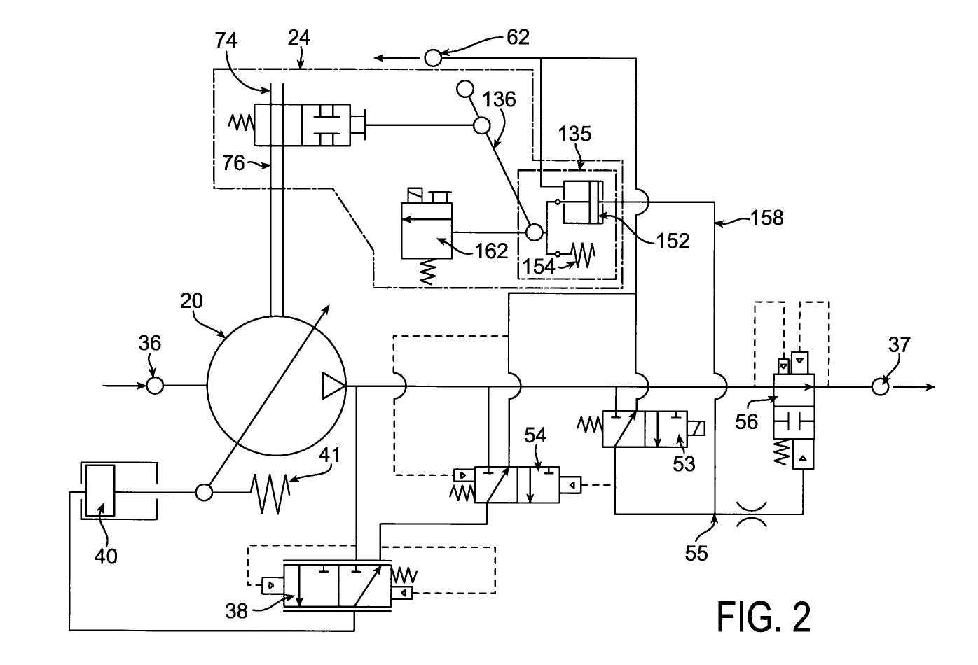

Referring to the drawings, and initially to FIGS. 1 and 2, a pump assembly constructed according to the present invention is indicated generally at 20. Pump assembly 20 includes a pump, indicated generally at 22, and a drive apparatus, indicated generally at 24, enclosed within a housing 30. The drive apparatus 24 is connected to a source of power 31, for example to the rotating shaft in the gearbox of an aircraft engine or other appropriate power source.

Pump 22 is generally illustrated as a conventional variable displacement axial piston pump with a mechanism including a rotating group of components (piston, cylinder barrel, etc.) and a displacement group of components (hanger plate, etc.) contained within a pump housing portion 35, and is only described briefly herein. It should be appreciated that the present invention can be used with other types of pumps or driven assemblies with rotating components.

The pump intakes fluid through an inlet port 36 and discharges the fluid under pressure through pump outlet 37. The pump outlet 37 is controlled and maintained at rated pressure by a three-way compensator valve 38, which controls a stroking piston 40 counteracted by a rate spring 41, such that the angle of the hanger is varied according to system flow demand..

A solenoid-actuated depress valve 53 and a depress spool and sleeve 54 operate in conjunction with one another to depressurize the pump and reduce the displacement of the pump. When activated, the depress valve 53 operates as a pilot valve to shuttle the depress spool and sleeve 54 to port adequate flow to the stroking piston via the compensator valve to destroke the piston and reduce the pump displacement. The output of the depress valve 53 is also applied through port 55 (FIG. 1) and is available to facilitate the disengagement of the mechanism, as will be described below.

Discharge from the pump is also controlled via a blocking piston 56, which is likewise activated by the depressurize flow from the depress valve 53. When the pump is depressurized, the blocking piston closes the outlet port 37 to stop outlet flow from the pump.

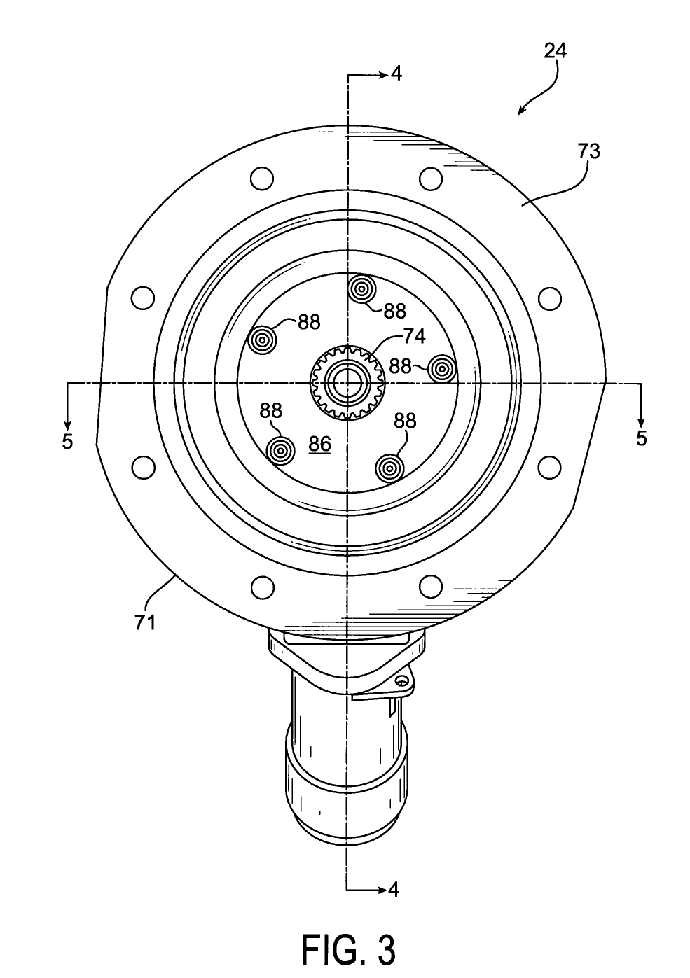

Referring now also to FIGS. 3-5, the drive apparatus 24 includes a drive mechanism, indicated generally at 70, enclosed within a housing portion 71. Housing portion 71 can be assembled and sealed at one end face 72 to pump housing portion 35; and mounted to the engine gearbox at the other end face 73. Drive mechanism 70 is operable to connect and disconnect the power path from the source of power 31 to the pump 22 (or other driven assembly), and includes an input drive shaft or member 74 projecting exteriorly of housing portion 71 which is connectable via a splined interface or other appropriate manner to the gearbox shaft of the engine; and an output drive shaft or member 76 which is connectable via a splined interface to the rotating components of the pump 22. Input member 74 is connected directly to an internal shaft 82 via a splined interface or other appropriate manner and rotate in conjunction with each other. The internal shaft member 82 is rotationally supported on front shaft bearing 84, which is outwardly held in place in a shoulder of face plate 86, and is allowed to rotate freely thereon. Face plate 86 is attached via fasteners 88 to the end of housing portion 71.

An annular interface shaft 92 is slidingly received on the externally splined end of internal shaft 82 and can reciprocate via cooperating splines along the shaft. The shaft 92 is rotationally supported on a journal bearing 93, and includes a radially-outwardly projecting head 94 with a flat annular surface which is axially supported against a thrust bearing 96 which itself is supported against washer 97; and an annular end face 98 with a series of gear teeth as at 99 radially oriented about the shaft centerline and projecting axially from the end. A compression spring 101 is provided between an annular shoulder in the cavity 102 of internal shaft portion 82 and an internal annular surface of end face 98 of interface shaft 92 and urges the interface shaft 92 towards the driven output member 76.

The output member 76 is likewise rotationally supported on a shaft bearing 104, which is outwardly held in place in an internal shoulder in housing 71, and is allowed to rotate freely thereon. Output member 76 includes an annular end face 108 with a series of gear teeth as at 110 also radially oriented about the shaft centerline and projecting axially from the end in a direction toward teeth 99 on interface shaft 92. Gear teeth 110 on output member 76 are configured so as to cooperatively engage corresponding gear teeth 99 when these components are in abutting relation, such that rotation of the input member 74 causes corresponding rotation of the output member 76.

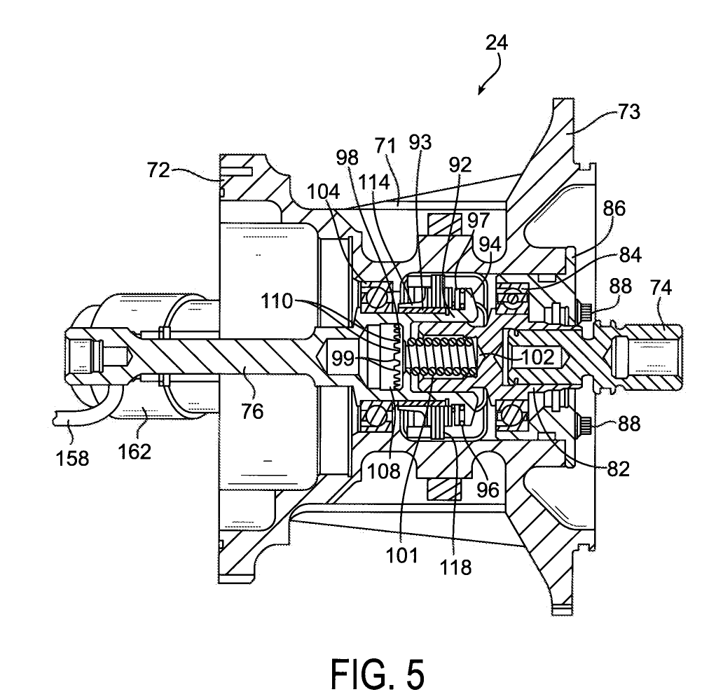

Journal bearing 93 is outwardly supported by an annular block member 114, and provides axial alignment to the rotatable sliding interface shaft 92. A pair of drive pins 118 (FIG. 5) project radially outward from opposite sides of the annular block member 114 and can be engaged (in a manner to be described below) to move the annular block member axially along the shaft's centerline. When the pins 118 are moved in an axial forward direction toward the input member 74, the forward end of the annular block member 114 is moved axially against the head 94 of the interface shaft 92, which moves the interface shaft along its splined connection, away from the output shaft 76. This moves the gear teeth 99 on input member 74 axially away from the corresponding teeth 110 on the output member, and thereby disengages the input member from the output member.

Likewise, when the pins 118 are moved in an axially rearward direction, toward the output member 76, the annular block member 114 is moved axially away from the head 94 of the interface shaft, and compression spring 101 forces the interface shaft along its splined connection, toward from the output shaft 76. As can be appreciated, this moves the gear teeth 99 on input member 74 axially toward and into engagement with the corresponding teeth 110 on the output member, which thereby connects or engages the input member to the output member. Thrust bearing 96 between the head of the interface shaft and the annular block member ensures the interface shaft 92 can smoothly rotate in conjunction with the input member and relative to the annular block member during disengagement. When engaged, substantially no load is applied to the bearing.

The force required to separate the sliding interface shaft from the output shaft increases proportionally with the input torque applied to the shafts. For a variable displacement hydraulic pump, this input torque is a function of the pump discharge pressure and the operating displacement. In other words, the separating loads are highest when the pump is operating at maximum pressure and full flow.

The gear teeth on the sliding interface shaft and on the output member can be identical and can be saw-tooth style teeth, or can have a modified saw-tooth type with engaging surfaces in each rotation direction, designed to facilitate engagement and disengagement, while also providing capability to transmit rotation in either direction.

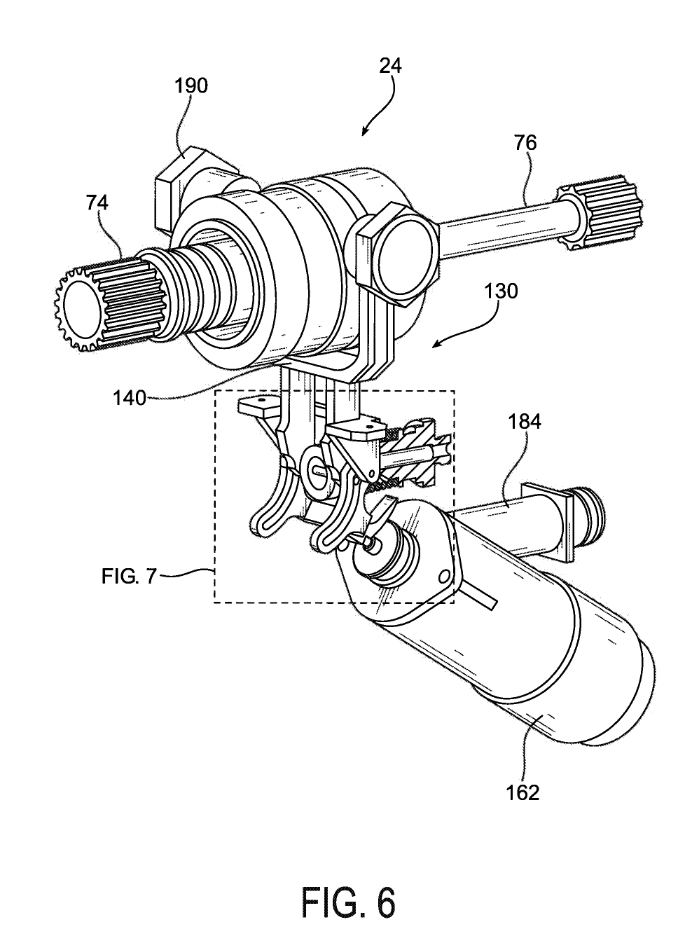

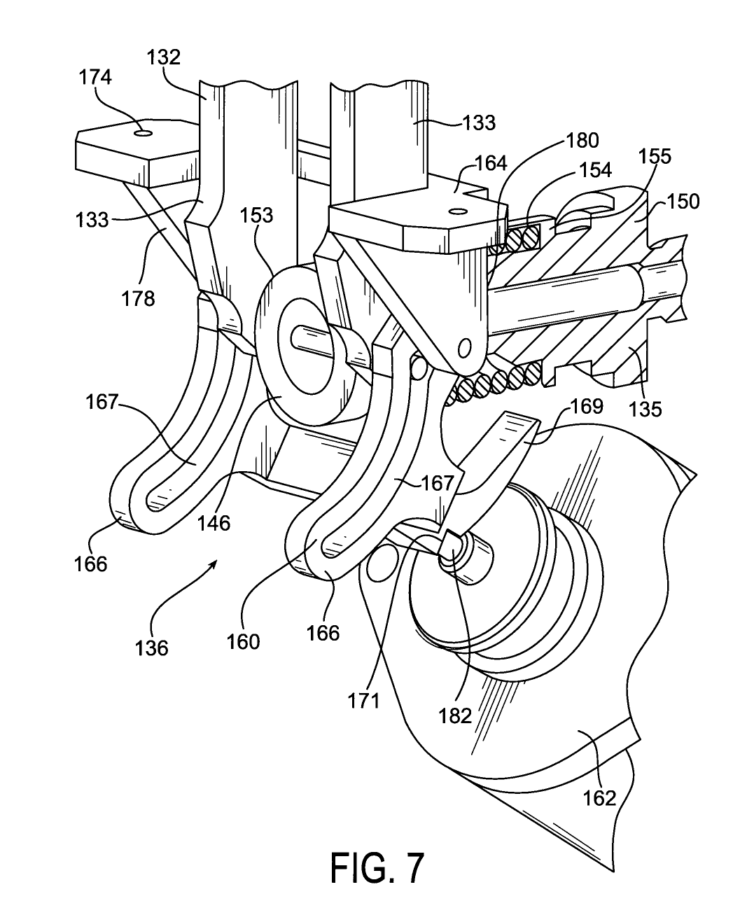

Referring now also to FIGS. 6-8, the drive apparatus 24 further includes a disconnect mechanism, indicated generally at 130, which includes i) a yoke 132 pivotally mounted and having a pair of elongated lever arms 133 (FIG. 7) in engagement with drive pins 118 assembled to the sliding annular block member 114; ii) an actuator assembly 135 to provide connection with the depressure port and to guide movement of the yoke; and iii) a trigger assembly, indicated generally at 136, for locking the yoke in an engaged condition where the gear teeth of the mechanism are engaged, and operable to release the yoke such that the actuator can move the yoke and cause the gear teeth to separate into a disengaged condition.

The yoke 132 includes a connecting assembly 140 supporting the lever arms 133 in generally parallel, spaced relation. The upper end of each yoke arm is pivotally mounted about a pivot axis on a pivot pin 142, which are fixed to opposite sides of the housing and then extend slightly angled rearwardly, and then vertically downward. The yoke arms each include a shoulder or slight recess 144 which has a geometry which receives a respective outwardly-projecting drive pin 118 from the sliding block member. The opposite end of each lever arm is pivotally mounted to the actuator assembly 135 via a link pin 146 (FIG. 7). While a pair of lever arms are described above extending from the pivot connection about the gear faces, to the pivot connection with the actuator, it is possible that the two arms could end at the connecting piece, and only a single lever arm could extend from the connecting piece to the actuator. The modification of the yoke and trigger assembly to accomplish this should be readily apparent.

Actuator assembly 135 includes an actuator body 150, a piston 152, a guide 153, and a compression spring 154 supported against a shoulder 155 and applied against the guide 153 to normally urge the guide 153 outwardly from the actuator body. Actuator body 150 is fixed within an aperture of housing 71. As shown in FIG. 1, the actuator includes a port 156 which is fluidly coupled via tubing 158 to the depressure port 55 in the pump. Pump 22 thereby communicates fluid under pressure to the actuator piston 152 when the pump is depressurized to assist in moving the piston outwardly from the actuator body.

Referring again to FIG. 7, trigger assembly 136 includes a trigger link 160, a solenoid actuator 162 and a trigger hinge 164. Trigger link 160 includes a pair of link arms 166, each of which includes an arcuate slot 167 which receives an opposite end of link pin 146. Link 160 includes a foot 169 having an outer extended angled (slightly curved) surface, and a shoulder 171. The trigger hinge 164 has a face plate 174 which is mounted appropriately to the housing 71, and includes a pair of side walls 178 which depend downwardly from the face plate on opposite sides of the trigger link arms 166 and which each support a pivot pin 180. Trigger link arms 166 are each connected to respective pivot pins 180 and the link thereby pivots around a pivot axis on a respective pivot pin.

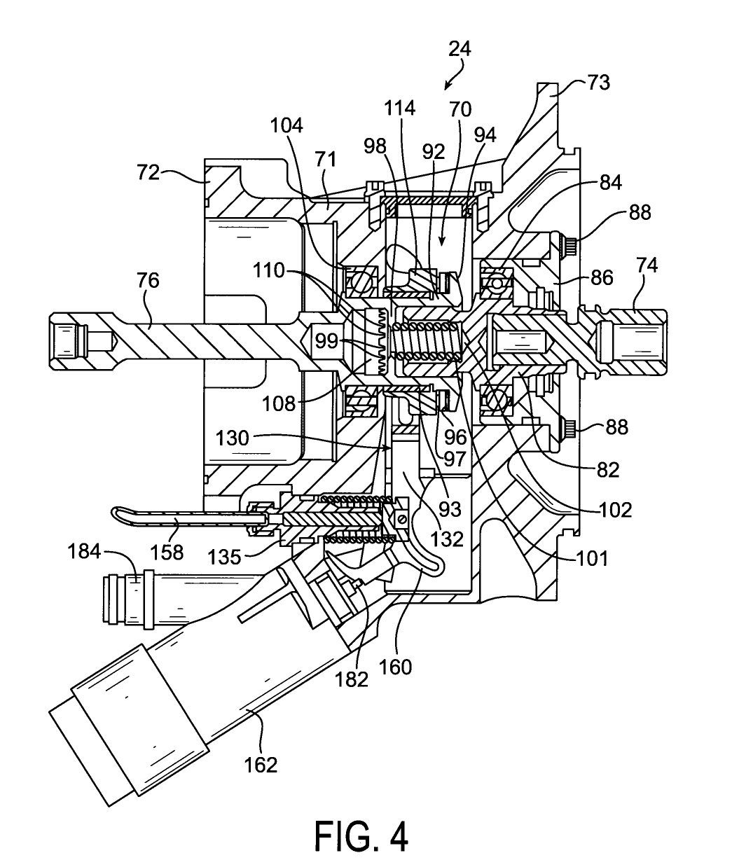

Solenoid actuator 162 includes a plunger 182 and has an electrical connection 184 to power the solenoid and receive actuation commands. As can be seen in FIGS. 6-8, the disconnect mechanism is in an “engaged” condition, whereby the actuator plunger 182 is extended, and locks to the shoulder 171 of trigger link 160. In this condition, the trigger link 160 is fixed for movement, the piston 152 and spring 154 of actuator assembly 135 are retracted, and the lever arms of the yoke are retained in a position where the gear faces of the input and output members are in their engaged condition (FIGS. 4 and 5).

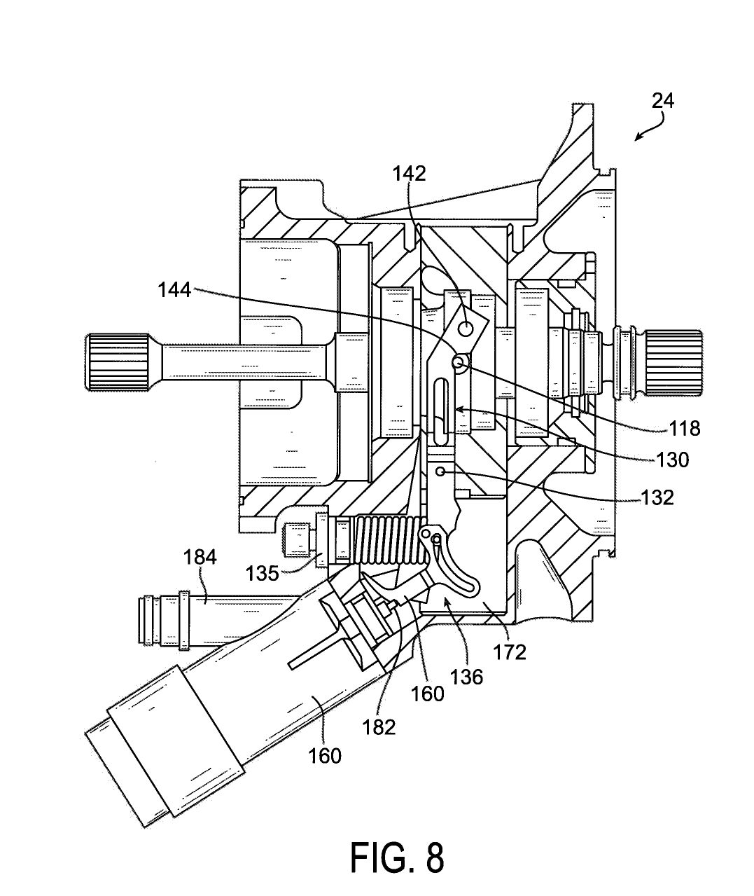

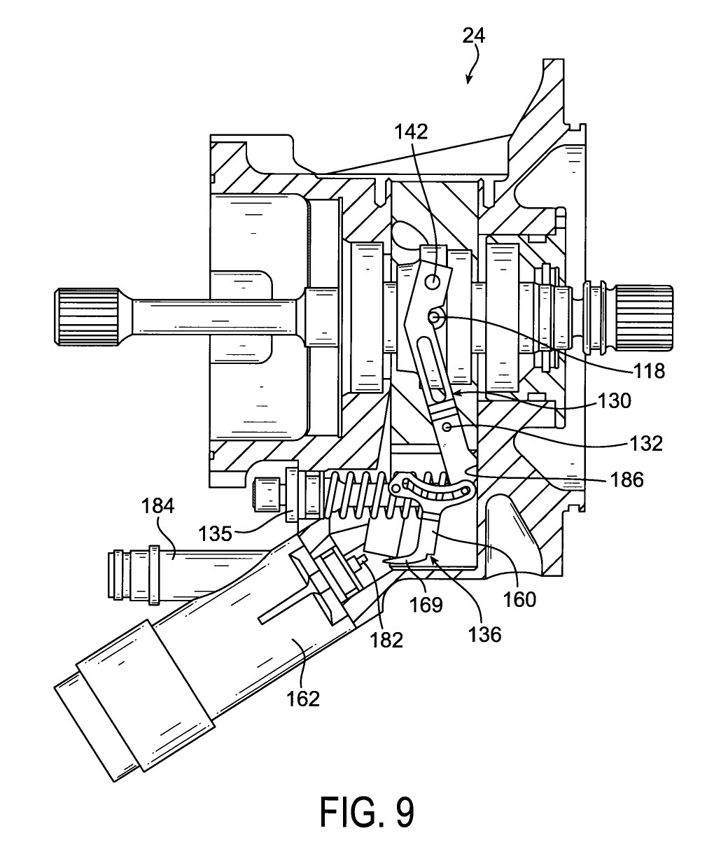

Upon receipt of an actuation command, the actuator plunger 182 retracts, which releases the trigger link 160. The compression spring 154 of actuator assembly 135 forces the guide 153 outwardly from the actuator body, thereby forcing the link pin 146 to ride along the arcuate slot 167 in the trigger link 160 as the trigger link pivots about its pivot pins 180 from a locked or engaged condition (FIG. 8) to an unlocked or disengaged condition (FIG. 9). At the same time, the actuator piston 152 assists the spring 154 in forcing the ends of the yoke lever arms 133 from a first (engaged) position shown in FIG. 8, to a second (disengaged) position shown in FIG. 9. The outward movement of the lever arms is limited by engagement of the arms with an inside wall surface 186 of the housing. The lever arms pivot about the pivot axis of the yoke, and in so doing, force the drive pins 118 from the (engaged) position shown in FIG. 8, to the (disengaged) position shown in FIG. 9, which thereby forces the sliding block member, and hence the interface shaft 92 (FIGS. 4 and 5) away from the output member to thereby disengage the teeth.

As indicated above, the actuator 135 has a single, lightweight spring 154 to assist in moving the yoke arm 132 from the engaged to disengaged condition. When the pump is non-operational or operational with no pressure, and the operational torque is minimal, the spring has sufficient force by itself to move the yoke arm into the disengaged position. When the pump is operational, and operational torque is being applied to the shafts, the assist from the pressure applied through the depressure valve on the actuator piston 152 is sufficient to move the yoke arm into the disengaged position and overcome the frictional forces of the spline interfaces and the gear teeth, particularly when the torque has been reduced by the depressure command to reduce the hanger angle in the pump.

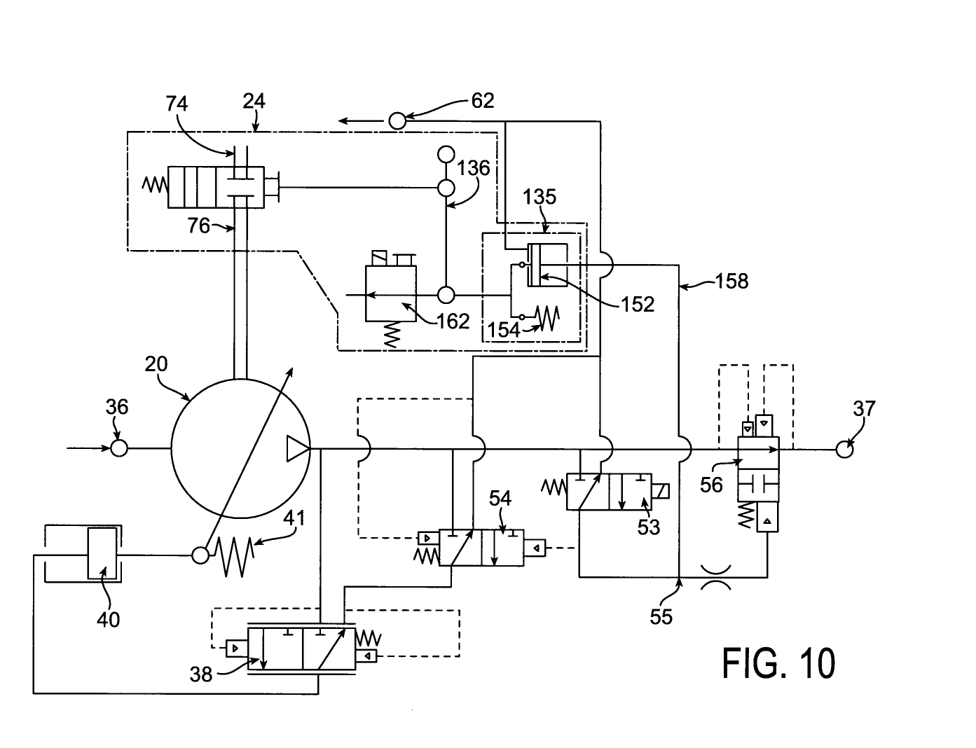

A schematic representation of the fluid circuit with the EDP disengaged from the source of power is shown in FIG. 10. When energized, the depress valve 53 directs fluid under pressure to the blocking valve 56 preventing flow through the outlet port 37 of the pump and to the actuator assembly 135. It can be seen that the stroking piston 40 is in the extended position where the hanger angle is reduced and the displacement of the pump is limited (the pump is at low torque). When energized, the disconnect solenoid 162 releases the disconnect mechanism 24, causing it to transition from the engaged position to the disengaged state.

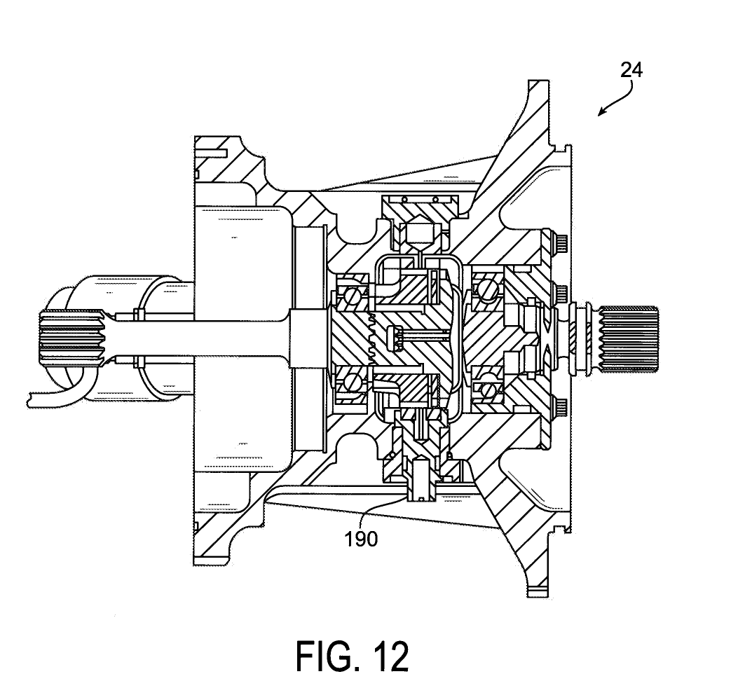

As should be appreciated, after the trigger link 160 has pivoted to the disengaged position, the link cannot automatically return to its engaged position. This prevents reengagement of a failed pump during flight. When the aircraft with disengaged EDP has landed and it is desired to reengage the pump, the engines are shut down, and a technician can access an external drive socket 190 (FIG. 12) co-axial with the axis of pivot pins 142, to rotate the yoke in an opposite direction and into the engaged condition. This causes link pin 146 to move along the grooves in trigger link 160, causing the trigger link to rotate back towards its engaged position. During re-engagement, the extended angled surface on the trigger link foot 169 pushes the solenoid plunger 182 back into the solenoid 162. The compression spring 101 provides an assisting load on the sliding interface shaft 92 to move the shaft towards the driven member and ensures proper teeth engagement once contact has been achieved during re-engagement. Once the trigger link has rotated such that the link shoulder 171 is beyond the solenoid plunger 182, the plunger extends into engagement with the shoulder to restrain the mechanism. At this point the disconnect mechanism is re-engaged.

The disconnect mechanism described herein utilizes a combination of hydraulic and mechanical force to translate the sliding interface shaft 92, resulting in disengagement of the drive teeth. Actuator spring 154 provides a constant mechanical load regardless of whether the pump is operating or not. A supplemental force is generated when hydraulic pressure is applied to the actuator piston 152.

The disconnect mechanism 130 is enclosed within a chamber 191 (FIG. 1) formed in housing portion 71, and is lubricated at all times by the fluid contained within the pump housing. The lubrication further reduces the separation force by reducing the coefficient of friction between the teeth and splined interfaces. In addition, the bearings and disconnect mechanism are protected in the housing from external contaminants.

As such, the disconnect mechanism described above is simple in operation, has fewer and lighter spring sets than known previous techniques, and disconnects the source of power from the driven assembly when the pump has low operating torque. There are also relatively few rotating components of the mechanism which reduces rotational inertia, and the components (other than the input shaft) are all protected within the pump assembly housing and are continually lubricated by the pump case fluid.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

What is claimed is:

1. A pump assembly including a housing having a fluid inlet port and a fluid outlet port, and a pump mechanism and drive apparatus enclosed within the housing, the pump mechanism capable of intaking fluid received in the inlet port and providing the fluid under pressure through the outlet port, and a depressure port which ports fluid from the housing during depressurization of the pump; the drive apparatus including a drive mechanism mechanically coupling a rotatable input member to the rotating assembly of the pump mechanism; the drive apparatus further including a disconnect mechanism including an actuator fluidly connected to the depressure port of the pump mechanism and operable under port pressure to urge the drive mechanism from an engaged state where power is transmitted from the input member to the rotating assembly, to a disengaged state, where power is interrupted from the input member to the rotating assembly.

2. The pump assembly as in claim 1, wherein the actuator includes a spring mechanism biasing the drive mechanism into the disengaged state.

3. The pump assembly as in claim 1, further including a trigger assembly normally retaining the drive mechanism in the engaged state, and operable to allow the drive mechanism to move to the disengaged state.

4. The pump assembly as in claim 1, wherein the disconnect mechanism includes a lever arm pivotally mounted about an axis and operatively connected to the drive mechanism and to the actuator, the lever arm pivotable about the axis when the drive apparatus is urged from the engaged state to the disengaged state.

5. The pump assembly as in claim 4, wherein the actuator includes a spring mechanism biasing the lever arm into the disengaged state.

6. The pump assembly as in claim 4, further including a trigger assembly normally retaining the lever arm in the engaged state, and operable to allow the lever arm to move to the disengaged state.

7. The pump assembly as in claim 4, wherein the drive mechanism includes a pair of opposing gear members, one of which is located on an sliding interface shaft which slides axially relative to the other of the gear members such that gear teeth on the opposing gear members can be brought into cooperative engagement with each other when the lever arm is in the engaged state, and can be separated from each other when the lever arm is in the disengaged state.

8. The pump assembly as in claim 7, wherein the lever arm is connected to an annular block member, which is rotationally fixed relative to the housing and provides axial support to the rotatable sliding interface shaft.

9. The pump assembly as in claim 1, wherein the drive mechanism includes a pair of opposing gear members, one of which is located on an sliding interface shaft which slides axially relative to the other of the gear members such that gear teeth on the opposing gear members can be brought into cooperative engagement with each other when the drive mechanism is in the engaged state, and can be separated from each other when the drive mechanism is in the disengaged state.

10. An assembly, including a housing and a drive apparatus in the housing, the drive apparatus including i) a drive mechanism mechanically coupling a rotatable input member to a rotatable output member; and ii) a disconnect mechanism including an actuator urging the drive mechanism from an engaged state where power is transmitted from the input member to the output member, to a disengaged state, where power is interrupted from the input member to the output member; the disconnect mechanism including a lever arm pivotally mounted about an axis and operatively connected to the drive mechanism and to the actuator, the lever arm pivotable about the axis when the drive mechanism is urged from the engaged state to the disengaged state, the drive mechanism including a pair of opposing gear members, one of which is located on an sliding interface shaft which slides axially relative to the other of the gear members such that gear teeth on the opposing gear members can be brought into cooperative engagement with each other when the lever arm is in the engaged state, and can be separated from each other when the lever arm is in the disengaged state, and wherein the lever arm is connected to an annular block member for axial movement thereof, the block member being rotationally fixed relative to the housing and providing axial support to the rotatable sliding interface shaft.

11. The assembly as in claim 10, wherein the actuator includes a spring mechanism biasing the lever arm into the disengaged state.

12. The assembly as in claim 10, wherein the actuator includes a piston operable under fluid pressure to bias the lever arm into the disengaged state.

13. The assembly as in claim 10, wherein the actuator includes a spring mechanism and a piston operable under fluid pressure to bias the lever arm into the disengaged state.

14. The assembly as in claim 10, further including a trigger assembly normally retaining the lever arm in the engaged state, and operable to allow the lever arm to move to the disengaged state.

15. A drive apparatus for transmitting force from a source of power to a driven assembly, the drive apparatus including a housing and a drive mechanism in the housing, the drive mechanism mechanically coupling a rotatable input member connectable to the source of power to a rotatable output member connectable to the driven assembly; the drive apparatus further including a disconnect mechanism including an actuator urging the drive mechanism from an engaged state where power can be transmitted from the source of power to the driven assembly, to a disengaged state, where power is interrupted from the source of power to the driven assembly, the disconnect mechanism including a lever arm pivotally mounted about an axis and operatively connected to the drive mechanism and to the actuator, the lever arm pivotable about the axis when the disconnect mechanism is urged from the engaged state to the disengaged state, the drive mechanism including a pair of opposing gear members, one of which is located on an sliding interface shaft which slides axially relative to the other of the gear members such that gear teeth on the opposing gear members can be brought into cooperative engagement with each other when the lever arm is in the engaged state, and can be separated from each other when the lever arm is in the disengaged state, and wherein the lever arm is connected to an annular block member for axial movement thereof, the block member being rotationally fixed relative to the housing and providing axial support to the rotatable sliding interface shaft.

16. The drive apparatus as in claim 15, wherein the actuator includes a spring mechanism biasing the lever arm into the disengaged state.

17. The drive apparatus as in claim 15, wherein the actuator includes a piston operable under fluid pressure to bias the lever arm into the disengaged state.

18. The drive apparatus as in claim 15, wherein the actuator includes a spring mechanism and a piston operable under fluid pressure to bias the lever arm into the disengaged state.

19. The drive apparatus as in claim 15, further including a trigger assembly normally retaining the lever arm in the engaged state, and operable to allow the lever arm to move to the disengaged state.

20. An assembly, including a housing and a drive apparatus in the housing, the drive apparatus mechanically coupling a rotatable input member to a rotatable output member and including an actuator urging the drive apparatus from an engaged state where power is transmitted from the input member to the output member, to a disengaged state, where power is interrupted from the input member to the output member; the drive apparatus including a lever arm pivotally mounted about an axis and operatively connected to the drive apparatus and to the actuator, the lever arm pivotable about the axis when the disconnect apparatus is urged from the engaged state to the disengaged state, the drive apparatus further including a pair of opposing gear members, one of which is located on an sliding interface shaft which slides axially relative to the other of the gear members such that gear teeth on the opposing gear members can be brought into cooperative engagement with each other when the lever arm is in the engaged state, and can be separated from each other when the lever arm is in the disengaged state, and wherein the actuator includes a spring mechanism and a piston operable under fluid pressure biasing the lever arm into the disengaged state.

21. The assembly as in claim 20, further including a trigger assembly normally retaining the lever arm in the engaged state, and operable to allow the lever arm to move to the disengaged state.
